(19) United States
(12) Patent Application Publication
(10) Pub. No.: US 2015/0355379 A1
(43) Pub. Date: Dec. 10, 2015

(54) LAYERS OR THREE-DIMENSIONAL SHAPED BODIES HAVING TWO REGIONS OF DIFFERENT PRIMARY AND/OR SECONDARY STRUCTURE AND METHOD FOR PRODUCTION THEREOF

(71) Applicant: FRAUNHOFER-GESELLSCHAFT ZUR FÖRDERUNG DER ANGEWANDTEN FORSCHUNG E.V., München (DE)

(72) Inventors: Herbert Wolter, Tauberbischofsheim (DE); Ruth Houbertz-Krauss, Wuerzburg (DE)

(21) Appl. No.: 14/760,137

(22) PCT Filed: Jan. 13, 2014
(86) PCT No.: PCT/EP2014/050491

§ 371 Date: Jul. 9, 2015

(30) Foreign Application Priority Data
Jan. 11, 2013 (DE) 10 2013 100 313.3

(51) Int. Cl. G02B 1/04; B29C 67/00

(52) U.S. Cl. CPC G02B 1/045; B29C 67/0066; B29C 67/0085; B33Y 10/00

(57) ABSTRACT

The invention relates to a layer or three-dimensional molded articles comprised of or composing an organically modified polysiloxane or a derivative thereof, the silicon atoms of which are completely or partially replaced with other metal atoms, wherein the organic share of the polysiloxane or derivative thereof has an organic cross-link with thiol-ene addition products bonded to silicon and/or to other metal atoms via carbon and/or oxygen, which are obtainable via a two-photon or multi-photon polymerization reaction, wherein the article has two areas with differing primary and/or secondary structures, available through the following process:
a) Providing a substrate or a mold,
b) Providing a material selected from sols, gels, and organically modified materials containing polysiloxanes, all of which contain metal and/or metalloid, wherein said provided material has free SH groups and isolated C═C double bonds,
c) Applying or attaching the provided material on or to the substrate or pouring it into the mold,
d) Selective exposure of a selected area of material located on the substrate or in the mold with the help of two-photon or multi-photon polymerization,
e) Thermal and/or photochemical treatment of the entire material located on the substrate or in the mold,
   with the provision that steps d) and e) can be conducted in any sequence.

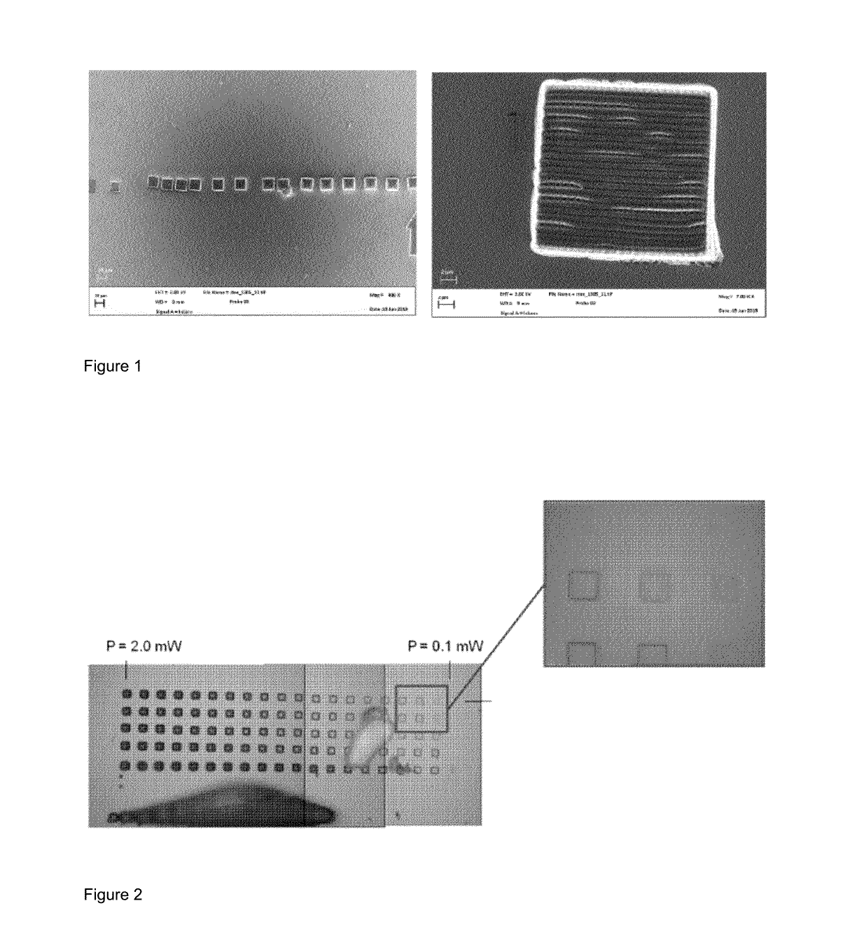

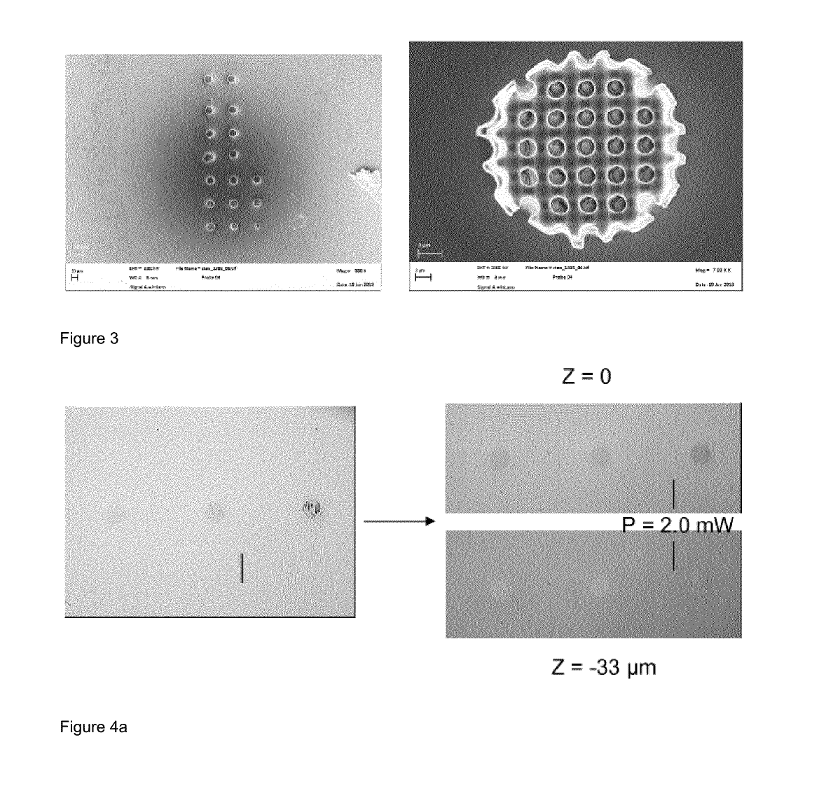

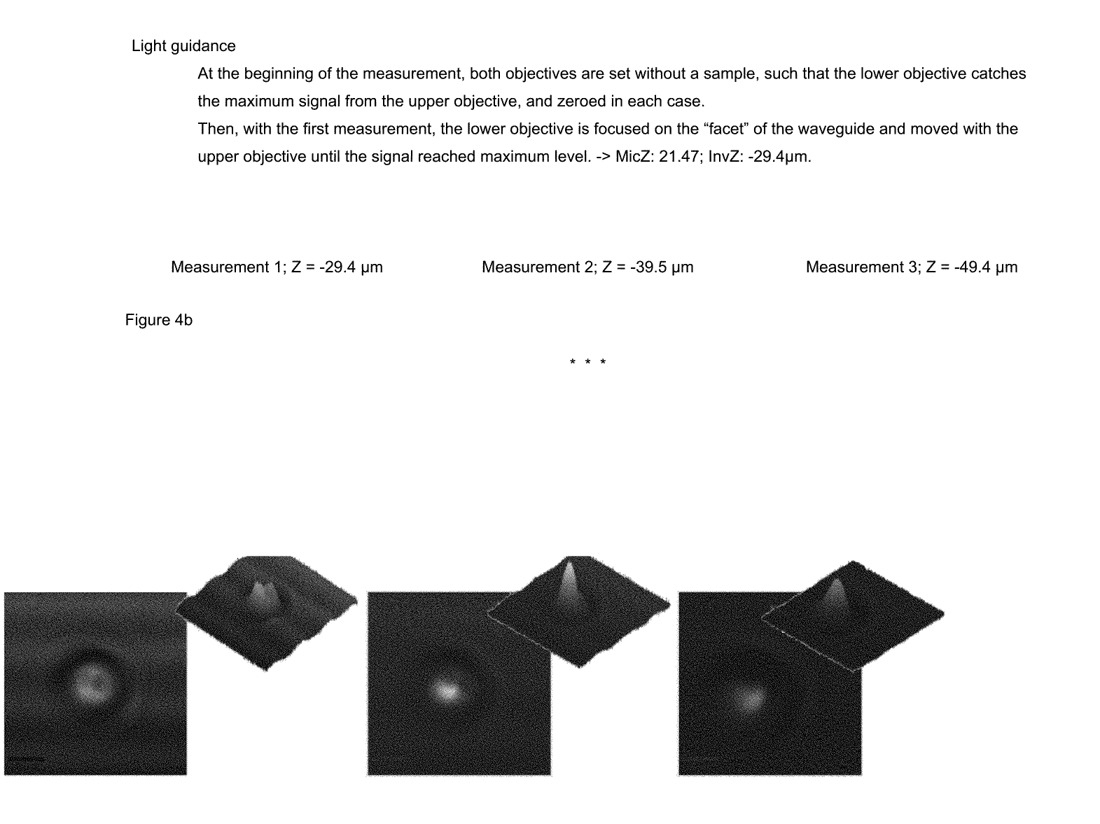

The material provided in step (b) is preferably selected from:
1. A mixture comprised of and containing (a) a material having organic groups bonded to the metal/metalloid via an oxygen bridge or via a carbon atom, which are substituted with one or more SH groups, and (b) a purely organic compound, which has two or more isolated C═C bonds,
2. A mixture comprised of and containing (a) a material having organic groups bonded to the metal/metalloid via an oxygen bridge or via a carbon atom, which have one or more isolated C═C double bonds, and (b) a purely organic compound, which is substituted with two or more SH groups, and
3. A mixture comprised of and containing (a) a material having organic groups bonded to the metal/metalloid via an oxygen bridge or via a carbon atom, which are substituted with one or more SH groups, and (b) having organic groups bonded to the metal/metalloid via an oxygen bridge or via a carbon atom, which have one or more isolated C═C bonds.

The present invention relates to special layers or three-dimensional molded articles produced from only one material having sections with differing primary structures (i.e. chemical connections, e.g. influencing the degree of cross-linking or based on rearrangements or repositioning) and/or secondary structures (in the present case, this refers to the order of the molecules in the molded article compound, which is influenced, e.g. through folds or compactions). Said varying primary and/or secondary structure of the different sections causes them to have differing physical or mechanical properties, for example different refractive indices or a different module of elasticity. In one specific embodiment, there is an initial section with cross-linked structures, while a second section still (at least organically) has the material in a non-cross-linked state. This may be subsequently washed out (“development” of the structure produced through cross-linking), such that a two-dimensional layer or a three-dimensional molded article can be formed with only one primary or secondary structure, though with specific forms. In this manner, for example, porous molded articles or structured layers can be produced without mask processes being necessary for the latter. Furthermore, the invention relates to processes for the production of these layers or molded articles.

The production of three-dimensional articles by irradiating predetermined voxels in a bath material with the aid of two-photon polymerization (2PP) has been known for some time. Initial attempts were successful with purely organic materials. WO 03/037606 A1 describes the production of three-dimensional articles comprised of polysiloxanes, which can be produced through the hydrolytic condensation of silanes with organic groups that are bonded via Si—C and capable of polymerization by means of radiation. The basis for the polymerization process presented there is two-photon polymerization (also called 2PP) induced through two-photon absorption (also called TPA), wherein it was possible to determine that the cross-section (the probability of 2P absorption) of the organic polysiloxanes was large enough to use this process for producing three-dimensional structures, whether in the form of (potentially self-supporting) articles or surface structures or other layers that are potentially held by a substrate. A lithographic resolution of approx. 100 nm by means of femtosecond laser irradiation, which, however, had not yet been optimized, is mentioned in WO 03/037606 A1.

A number of publications have since been devoted to this topic; to a large degree, the process removed and refined previously conventional stereolithography through its high resolution, smallest structures in the range of 100 nm or smaller, and the very high finish quality achievable in the process. Using two-photon polymerization enables the production of, for example biocompatible, bioresorbable or biodegradable structures, which can be used as scaffolds for linking living cells or for implants. These materials can also be based on respectively modified polysiloxanes—see WO 2011/98460 A1. Additional suggestions relate to the selective exposure of hydrogels comprised of methacrylated poly(ε-caprolactone)-based oligomers or poly(ethylene glycol) diacrylate by means of 2PP—Jenni E. Koskela et al. in Polym. Adv. Technol. 23, 992-1001 (2012). Another approach is revealed in WO 2011/147854 A1. This publication deals with the production of structured molded articles as well as thin or even thicker layers of organometallic compounds capable of being organically cross-linked through photochemical processes, from which technically relevant oxidic function bodies or layers can be produced, e.g. in the form of magnetic or piezoelectric active sensors or actuators or (energy) converters, such as ultrasound transducers comprised of LZT (lead zirconate titanate) or BTO (barium titanate), through sintering and potentially subsequent physical activation, for example polarization with the aid of an electric field, or, if magnetic materials are contained therein, activation through a magnetic field.

In all the aforementioned cases, the three-dimensional article or the structured surface is developed due to the fact that non-exposed bath material is washed out.

There are cases, in which the article manufactured in this manner is intended to be embedded in another material, which has other physical properties. One prominent example for this is the production of waveguides that have to be embedded in cladding as a “core” in order to affect the refractive index difference between the medium of the waveguide itself and the adjacent medium. Due to the fact that polymerized polysiloxanes normally have a high transmission rate for visible light and adjacent areas as well, they are potential candidates for such waveguides. In this regard, it should be noted that the entire range from UV to IR is of interest—materials transmitting in the visible or very close infrared range are suitable, e.g. for multi-mode waveguides (a wavelength, e.g. of 850 nm is used) as well as utility articles; single-mode waveguides that are used in the area of data transmission frequently use the wavelength 1310 and 1550 nm. UV light is used in blue ray (DVD) players. The smaller the wavelength used, the denser, finer structures can be produced, which in the context of data carriers means that they can record more data on the same surface than written with larger wavelengths.

Today, waveguides are still produced in part through “classic” exposure. Thus, e.g. in Optics Express 20 (6), 6575-6583 (2012), Chunfang Ye et al. suggest producing waveguides through directly inscribed lithography. Photopolymers that were developed for holographic data storage serve as the basis for them. These photopolymers comprise a solid, though flexible matrix as well as photoactive components, namely a suitable photoinitiator and a monomer that polymerizes through a reaction with the excited initiator. Local exposure of the materials causes the resulting polymer accumulates in the exposed areas, while its concentration decreases in the non-exposed areas due to diffusion processes. The authors consider this to be the cause for a local increase of the refractive index. After completion of selective exposure, the entire material is exposed in order to “consume” the remaining initiator and remaining monomer, and a material that is no longer chemically or optically reactive, the optical properties of which differ in the selectively exposed areas from the non-selectively exposed areas. Both areas could be used as a “core” and “cladding” of a waveguide.

There have also been attempts to use 2PP for similar processes. In the Journal of Laser Micro-Nanoengineering 6 (3), 195-198 (2011), J. Kumpfmüller et al. suggest using a silicone polyether acrylate resin as a basis, which was made in a thixotropic manner with the help of a rheology additive. Trimethylolpropane triacrylate and a photoinitiator were added to this mixture. Based on phase contrasts, the authors were able to demonstrate the production of structures that could be suitable as waveguides. This group also assumes that the various properties of the differently exposed material are based on the diffusion of the monomer. However, a thixotropic material is unsuitable as the “cladding” of a waveguide as it is not mechanically stable and the optical quality is frequently too low.

In Optical Materials 34 (2012) 772-780, S. Bichler, S. Feldbacher, R. Woods, V. Satzinger, V. Schmidt, G. Jakopic, G. Langer, W. Kern manufactured a material, the matrix of which was produced by reacting a hydridosilane with a vinyl silane by means of classical hydrosilylation (in the presence of a platinum catalyst). Benzyl methacrylate or phenyl methacrylate served as monomers, which were chosen due to their high refractive index. Ethylene glycol dimethacrylate served as a cross-linking agent for the photo-induced polymerization. Irgacure 379 was used as a photoinitiator. In the first step, the material was heated, wherein the siloxane matrix formed, in which the monomeric material was present in a dissolved state. A selective 2PP exposure was then conducted to produce optical waveguides, the finally the non-reacted monomer was extracted from the area of the non-exposed matrix through vacuum extraction in order to stabilize it. The photo-induced polymerization reaction of the methacrylate monomers was observed with the aid of FT-IR spectroscopy and phase contrast microscopy. The hydrosilylation used for the production of the matrix resulted in silicone rubber, such that the produced waveguide structures as well as the surrounding matrix were flexible.

There is still a need for materials for producing structural cross-links capable of having random shapes, for example being nano-structured or micro-structured, which can be used, e.g. in the area of 3-D optical interconnects or based on areas with a differing modulus of elasticity, and which have areas with differing primary and/or secondary structures (as defined above) within a molded article produced from a single material. In particular, there is a need for materials, with which solid, stable structures can be produced in a very simple manner having varying physical properties (for example optical or mechanical) within their structure (i.e. within the solid object, of which the structure is composed).

Surprisingly, the inventors of the present invention were able to determine that a workaround can be developed in this case, namely through the recommendation of providing a material containing polysiloxane modified with an organic radical that is polymerizable via 2PP or multi-photon polymerization or a sol or a gel having a metal coordination complex modified with an organic radical that is polymerizable via 2PP or multi-photon polymerization, in combination with a component containing SH groups, which enables the formation of thiol-ene addition products, and subjecting this material to (locally) selective two-photon or multi-photon polymerization and overall to a thermal and/or photochemical process step or a wash cycle, wherein the first of the mentioned steps is conducted prior to or after 2PP or multi-photon polymerization.

Surprisingly, the inventors were able to determine namely that a selectively exposed structure emerges embedded in a fully solidified material or in the direct vicinity thereto upon using this material and this process sequence, wherein the selectively exposed area features structural changes compared to a non-selectively exposed area, such as a differing primary and/or secondary structure, as described above, including possibly or in some cases a higher cross-linking of organic components in the selectively exposed area. The fact that the photochemical process step may comprise an exposure up to beyond the saturation limit of the 2PP or multi-photon polymerization process and that an exposure of the entire material may instead or additionally occur prior to the selective exposure, however, suggests that the differences are not necessarily variations in the degree of cross-linking of the organic network, but rather that effects such as reordering processes, rearrangements or compactions (e.g. while relieving stress) play a role, which possibly result in an inorganic network (i.e. the formation of higher molecular units), although the material—provided that it is produced according to the sol-gel process—had already previously reached the maximum degree of condensation possible under the selected conditions. These structural variations result in differing physical properties. The selectively exposed structure can thus have a refractive index, which conveniently differs from that material of the surrounding or adjacent, completely solidified material and is particularly higher, such that the formed structure can be used, e.g. as the “core” and “cladding” of exposed waveguides, or both areas may have varying mechanical properties, such as different elastic moduli or strengths.

In the following, the term “2PP” is not merely intended to encompass two-photon polymerization, but rather polymerization reactions as well that occur through absorption of more than two photons, thus so-called multi-photon polymerization (MPP). 2PP or multi-photon polymerization is triggered by 2PP or multi-photon absorption, called TPA (two-photon absorption) or MPA (multi-photon absorption). However, the use of the term TPA in the following should always imply that MPA is included.

If the term “(meth)acryl” is used in the following, this either refers to the methacryl group and/or the acryl group. The same applies for the terms “(meth)acrylate”, “(meth)acrylamide”, and “(meth)acrylthioester”.

A multitude of partially known materials can serve as a modified material containing polysiloxane or as a sol or gel having a metal coordination complex modified with an organic radical that is polymerizable via two-photon or multi-photon polymerization. It is necessary that the material has groups that are polymerizable via TPA (or MPA) can be subjected to thiol-ene addition while forming respective thiol-ene addition or polymerization products. If the material has non-aromatic C═C double bonds as “En” components, e.g. isolated double bonds, such as vinyl groups, or in allyl or styryl groups or in α,β-unsaturated carbonyl compounds, under the conditions of TPA, they can be charged by present thiol groups. These types of thiol-ene addition reactions occur radically. Those materials that were already subjected to TPA will be referred to as “having organic structures resulting from thiol-ene addition obtained through two-photon or multi-photon polymerization” or “having bridged and/or polymerized structures as a result of thiol-ene addition via two-photon or multi-photon polymerization”.

The inventors determined that at least one part of the groups available for thiol-ene addition via TPA, i.e. groups having at least a part of the groups containing C═C double bonds and/or a part of the SH radicals, should be bonded to an oligomer or polymer containing metal or metalloid for the suitable materials, wherein the radicals that have the mentioned groups can be bonded to the metal potentially via an oxygen bridge. However, bonds via a carbon atom are preferred, and particularly preferred is the bond to a silicon atom via a carbon atom in the compound of an organically modified polysiloxane or silicic acid (hetero) polycondensate. The effects determined now for the first time are possibly based on the fact that the bridging, which is caused by the thiol-ene addition, in the material used pursuant to the invention are integrated into the inorganic cross-link as a result of bonding to the respective metals/metalloids and therefore cannot form a cross-link separate from the inorganic cross-link.

Thus, pursuant to the invention, a layer or a three-dimensional molded article is provided comprising a material containing organic structures developed through thiol-ene addition and obtained via two-photon or multi-photon polymerization, wherein at least one part of the groups, which have structured bridged and/or polymerized via thiol-ene addition as a result of conducting TPA, is bonded to the metal/metalloid of an oligomer or polymer containing metal or metalloid via an oxygen bridge and/or via a carbon atom, wherein said article has two areas that are structurally, i.e. with respect to their primary structures or secondary structures (as defined above) different and at the same time preferably have different degrees of cross-linking and/or different refractive indices and/or elastic moduli, (or, expressed differently—a layer or a three-dimensional molded article comprised of or composing an organically modified polysiloxane or a derivative thereof is provided, the silicon atoms of which are completely or partially replaced by other metal atoms, wherein the organic share of said polysiloxane or derivative thereof has an organic cross-link with thiol-ene addition products bonded to silicon and/or other metal atoms via carbon and/or oxygen, which are available via a two-photon or multi-photon polymerization reaction, wherein the article has two areas with differing primary and/or secondary structures), available through the following process:

a) Providing a substrate or a mold,

b) Applying a material containing organic radicals polymerized via two-photon or multi-photon polymerization, wherein at least one part of the groups, which can form polymers via TPA, is bonded to the metal/metalloid of an oligomer or polymer containing metal or metalloid via an oxygen bridge or via a carbon atom, onto the substrate or pouring it into the mold,

c) Selective exposure of a selected area of material located on the substrate or in the mold using two-photon or multi-photon polymerization,

d) Thermal or photochemical processing of the entire material located on the substrate or in the mold,

wherein the sequence of steps c) and d) can be selected randomly.

In one series of embodiments, it is simultaneously preferred to harden the entire material according to step d) after selective exposure was conducted.

As a material usable pursuant to the invention, which is available for thiol-ene addition with the help of 2PP or MPP, wherein at least one part of the groups, which can be bridged through thiol-ene addition as a result of conducting TPA or MPA and/or therefore have polymerizable structures, is bonded via an oxygen bridge or via a carbon atom to the metal/metalloid of a oligomer or polymer containing metal or metalloid, those materials that have free SH groups and isolated C═C double bonds are suitable. Preferably, they can be taken from three fundamental material classes. These materials can be characterized as follows:

1. A mixture comprised of (a) a material having organic groups bonded to metal/metalloid via an oxygen bridge or a carbon atom, which are substituted with one or more SH groups, and (b) a purely organic material (of such a monomeric, potentially instead/additionally oligomeric and/or polymeric compound) having two or more isolated C═C double bonds,

2. A mixture comprised of (a) a material having organic groups bonded to metal/metalloid via an oxygen bridge or a carbon atom, which have one or more isolated C═C double bonds, and (b) a purely organic material (of such a monomeric, potentially instead/additionally oligomeric and/or polymeric compound), which is substituted with two or more SH groups, and

3. A mixture comprised of (a) a material having organic groups bonded to metal/metalloid via an oxygen bridge or a carbon atom, which are substituted with one or more SH groups, and (b) a material having organic groups bonded to metal/metalloid via an oxygen bridge or a carbon atom, which have one or more isolated C═C double bonds.

In all cases, it is preferred that silicon is involved at least in a part of the metal/metalloid.

In any case, the material having organic groups bonded to metal/metalloid via an oxygen bridge or a carbon atom can be a monomeric material, for example, a silane or an already pre-condensed materials, for example, a silicic acid (hetero) polycondensate, wherein the term “hetero” means that a part of the silicon atoms is replaced by other metal atoms, as is known in the state of the art.

In any case, the material having organic groups bonded to metal/metalloid via an oxygen bridge or a carbon atom, and/or the purely organic material, if present, can have reactive groups, for example, epoxy groups. Under the conditions of TPA, these groups will likewise be polymerized, which further increases the cross-link density through additional organic bridge formations.

The polysiloxanes or silicic acid (hetero) polycondensates usable pursuant to the invention may be those that are known in the state of the art. Thus, thiosilanes are revealed in WO 2007/002270 and norbornene silanes are known from WO 2007/002272 A1, which can be reacted with thiosilanes, etc., wherein an organic cross-link is developed. These norbornene silanes as well as other, likewise isolated silanes containing C═C bonds can be depicted through a following formula (I)

R¹ₐR²_{b}SiX_{4-a-b} (I)

wherein R¹ is equal or different and represents a radical having an isolated C═C double bond, R² is equal or different and represents an organic radical having no such C═C bond, and X is a radical that can be hydrolyzed out from silicon under hydrolysis conditions, the index a represents 1, 2 or 3, the index b represents 0, 1 or 2, and a+b together are 1, 2 or 3. In particular, radicals—in addition to vinyl or allyl radicals having an α,β-unsaturated carbonyl compound—as well as ring systems and, in particular, condensed ring systems containing double bonds, such as the norbornenyl radical and derivatives thereof having, for example, one of the following structures, are suitable as radicals R¹:

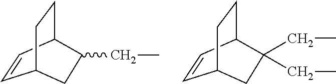

The polyaddition (thiol-ene addition) occurring when combining one or more such silanes or silicic acid (hetero) polycondensates (resulting through hydrolytic condensation) with thiols or thiosilanes (wherein in the latter case, a hydrolytic condensation of both components together may occur after combining) leads to the formation of organic bridges between radicals R¹ and the compound containing thiols. If the thiol is a thiosilane, organic bridges form in addition to the inorganic cross-link of silicic acid (hetero) polycondensate, which enable the entire cross-link to become more closed interlinked. The same applies if the thiol is a dithiol or a higher-order thiol as this connects (at least) two radicals R¹ via one organic bridge.

In another embodiment of the invention, an organically modified material containing polysiloxanes is used, which is available through hydrolysis and at least partially condensation of a starting material, which is comprised of or composing at least one silane of a formula (I′),

R³ₐR²_{b}SiX_{4-a-b} (I′)

wherein R³ is equal or different and represents an organic radical capable of polyaddition via two-photon or multi-photon polymerization, which carries at least one SH group, R² is equal or different and represents an organic radical that cannot be polymerized in this manner, and X is a radical that can be hydrolyzed out from silicon under hydrolysis conditions, the index a represents 1, 2 or 3, the index b represents 0, 1 or 2, and a+b together are 1, 2 or 3, as well as a silane of said formula (I) as specified above or an organic compound containing at least two isolated C═C double bonds.

Additional silicic acid (hetero) polycondensates, which are available for a thiol-ene addition upon adding a thiol, are revealed in WO 2013/053693 A1. Reference is also made in DE 4011044 C2 that trimethylolpropane triacrylate (TMPTA) or dipentaerythritol pentacrylate can be initiated into a reaction with a mercaptoalkylalkyldialkoxysilane or a mercaptoalkyltrialkoxysilane.

Instead of a silane of said formula (I) or additionally, for example, sols or gels can be used that were obtained through the following steps: (a) Dissolving at least one compound of one or more metals selected from magnesium, strontium, barium, aluminum, gallium, indium, silicon, tin, lead, and the transition metals in an organic solvent and/or replacing a ligand of the or of one of the dissolved metal compound(s) with a stabilizing ligand, (b) Adding a ligand to the solution, which has at least one photochemically polymerizable or summable group and at least one such group that enables a stable complex formation with the respective metal atom, and developing a sol with or from the product of this reaction (precursor), wherein said photochemically polymerizable group has the same meaning as radical R¹ in the silane of the aforementioned formula (I). These sols are revealed in WO 2011/147854 A1.

Examples of thiolsilanes pursuant to the invention are:

3-Mercaptopropyl trimethoxysilane

3-Mercaptopropyl triethoxysilane

3-Mercaptopropyl methyldimethoxysilane.

The following are examples of purely organic thiol compounds usable pursuant to the invention:

Trimethylolpropane tri(3-mercaptopropionate) (TMPMP)

Trimethylolpropane trimercaptoacetate (TMPMA)

Pentaerythritol tetra(3-mercaptopropionate) (PETMA)

Pentaerythritol tetramercaptoacetate (PETMA)

Glycol dimercaptoacetate

Glycol di(3-mercaptopropionate)

Ethoxylated trimethylolpropane tri(3-mercaptopropionate)

4,4′-Thiobisbenzenethiol

4,4′-Dimercaptostilbene.

The purely organic, isolated C═C bonds usable pursuant to the invention having compounds may have, for example, (meth)acryl groups, more preferred methacryl groups, particularly acrylate and/or methacrylate groups, wherein the methacrylate groups can then react partially in a photoinitiator-induced manner with additional organically polymerizable C═C double bonds present in polysiloxane, partially independent of the presence of a photoinitiator with the present thiol groups.

The production of organically modified polysiloxanes or silicic acid condensates (frequently also referred to as “silane resins”) and their properties has been described in a number of publications. As a representative of this, reference is made, for example, to Hybrid Organic-Inorganic Materials, MRS Bulletin 26(5), 364ff (2001). Broadly spoken, such substances are normally produced with the help of the so-called sol-gel method, in which hydrolysis-sensitive, monomeric or pre-condensed silanes are subjected to hydrolysis and condensation, potentially in the presence of additional co-condensable substances, such as alkoxides of boron, germanium or titanium, as well as potentially additional compounds, which can serve as modifiers or cross-link converters, or other additives, such as fillers. Materials that are suitable for the present invention as silanes containing C═C double bonds are, for example, additionally specified in DE 4011044C2, EP 450624 B1, EP682033 B1, EP 1159281 B1, EP 1685182 B1, EP 1874847 B1, and EP 1914260 A1. These materials are distinguished by the fact that they have radicals bonded to silicon via carbon, which have one or more groups R¹ that are organically polymerizable via 2PP (TPA). Acryl and methacryl groups are or may be present in most of these materials, which correlate to the aforementioned radical R¹; alternatively, e.g. norbornenyls as well as homologs or other condensed systems containing double bonds, such as vinyl, allyl or styryl groups, are suitable as a radical R¹. With respect to the usable norbornenyl silanes and applied compounds, we can also refer to the previously aforementioned DE 196 27 198 A1. Thus, the norbornene ring can naturally be potentially substituted; even a bicyclo[2.2.2]octane radical can be present instead of the norbornene radical (i.e. the bicyclo[2.2.1]heptene radical). Furthermore, the five-membered ring of the condensed system containing double bonds can contain an oxygen atom if the (meth)acryl group is reacted with furan instead of cyclopentadiene.

The aforementioned list, however, should not be considered to be final, which can be seen in the following explanations.

In addition to a silane of said formula (I) and/or said formula (I′), additional silanes can be used pursuant to the invention. One preferred combination uses both silanes Ar₂Si(OH)₂ and R¹Si(OR′)₃, wherein Ar is an aromatic radical having 6 to 20 carbons, in particular potentially substituted aryl and very particularly preferred an non-substituted phenyl radical bonded directly to silicon, and R¹ has the meaning specified for formula (I) and preferably at least one epoxy group or one C═C double bond, particularly having a double bond available for Michael addition (e.g. it is a (meth)acrylate group). Very particularly preferred, R¹ in this combination is a methacryloxy-alkyl, e.g. a methacryloxy-propyl group. Co-condensation products, in which Ar₂ and/or R₁ represent styryl groups, are possible. The production of a silane condensate from a mixture of diphenyl silane diol and 3-Methacryloxypropyltrimethoxysilane and in the molar ratio of 1:1 is described in example 1 of DE 199 32 629 A1; the selected ratio leads to the fact that hydrolysis occurs through the exclusive use of catalytic amounts of water. Pursuant to the invention, the starting materials used for this can be used with a thiosilane or a di or higher-order organic thiol. Thus, materials can be produced that have a low absorption rate at 1310 and 1550 nm in the field of telecommunication due to the lack of oscillations of the OH group.

Preferably, the radical R¹ in formula (I) above contains one or more double bonds available for Michael addition, e.g. α,β-unsaturated carbonyl compounds. These can be acryl or methacryl groups, particularly in the form of (meth)acrylate, (meth)acrylamide, and (meth) acrylthioester. R² can potentially be a substituted alkyl, aryl, alkylaryl or arylalkyl group, wherein the carbon chain of these radicals can be broken potentially through O, S, NH, CONH, COO, NHCOO, or similar. In this context, R² can also contain groups that can undergo an addition reaction with C═C double bonds, or contain a group relevant for biological purposes as revealed in WO 2011/98460 A1. The group X is normally hydrogen, halogen, alkoxy, acyloxy or NR⁵₂ with R⁵ equal to hydrogen or lower alkyl. Alkoxy groups are preferred as hydrolysable groups, particularly lower alkoxy groups, such as C₁-C₆-Alkoxy.

The organopolysiloxane capable of solidification can be produced using at least one additional silane of a formula (II),

SiX₄ (II)

wherein X is equal or different and has the same meaning as in formula (I). A compound that can be used well for this purpose is tetraethoxysilane. By adding these silanes to the mixture to be hydrolyzed and condensed, from which polymerizable bath material is finally produced, the SiO percentage of the resin, i.e. the inorganic percentage, is increased. Thus, the absorption of the resin into the wavelengths of interest can be reduced.

Conversely, the silane polycondensate to be organically polymerized may have been produced using at least one silane of a formula (IV),

R¹ₐSiR²₄₋ₐ (IV)

wherein R¹ and R² have the meaning specified above for formula (I). Thus, the degree of cross-linking of the polycondensate is reduced.

Furthermore, R¹ can be an organic radical polymerizable via two-photon or multi-photon polymerization that is different than R¹ of formula (I).

The mixture, from which the silane condensate is produced, may still contain a silanol of a formula (III),

R⁴ₐSi(OH)₄₋ₐ (III)

wherein R⁴ can be the same or different and respectively has the meaning of R¹ as defined in formula (I) or of R² as defined in formula (I), and wherein the index a represents 1, 2 or 3, preferably 2. Hydrolysis may therefore occur in the presence of these compounds with the help of catalytically effective amounts of water; incidentally, the system can remain free of water. In one preferred design of the invention, disilanols of said formula (III) are used with silanes of said formula (I), which preferably contain a group R¹, in a mixture ratio of 1:1 (mol/mol) as starting material to be hydrolyzed and condensed.

If R² is not present in formula (I) or has no functional groups, in one specific design, at least one silane of a formula (V) can be added to the material to be hydrolyzed and condensed,

R³ₐSiX₄₋ₐ (V)

wherein R³ carries a group, which can be added radically to a C═C double bond, particularly a thiol group. Respective condensates are then available for polymerization through addition reactions of the groups R³ of silanes of said formula (V) to double bonds of the radicals R¹ of silanes with formula (I).

The mixture to be hydrolyzed and condensed for the purposes of the present invention can contain additional substances, e.g. preferably lower alkoxides, particularly C₁-C₆ alkoxides, of metals of the third primary group, of germanium, and of metals of the second, third, fourth, fifth, sixth, seventh, and eighth sub-group.

Overall, the organically modified silicic acid polycondensate, from which the articles can be produced pursuant to the invention, should preferably have at least 0.1 mol of groups available for 2PP or MPP (R¹ of formula (I)), with respect to the molecular volume of silicon atoms, plus potentially the metal atoms of the third primary group, of germanium, and the second, third, fourth, fifth, sixth, and seventh sub-group, if present.

In one preferred embodiment of the invention comprising all aforementioned designs, the material, which is solidified on the specified substrate or in the specified mold, contains at least one silane with at least one radical R¹ or at least one radical R³ as specified above and additionally a purely organic monomer or oligomer or polymer available for two-photon or multi-photon polymerization, wherein this purely organic compound is available to the same two-photon or multi-photon polymerization reaction as the radical R¹ or R³ on the (pre-condensed) silanes of said formula (I). In one preferred embodiment, this involves the same radicals R¹. In a more preferred embodiment, the organic monomers are selected from monomers, which the help of which the silanes of formula (I) or (I′) were produced. Particularly favorable in this case are acryl and methacryl compounds, such as (meth)acrylates.

However, in an alternative embodiment, the monomeric, organically polymerizable compounds may also be different compounds than those used for the production of the silanes. In this regard, those monomers capable of being photochemically co-polymerized with radicals R¹ of the siloxanes can be selected. They react partially with themselves when subjected to irradiation and partially with the organically polymerizable groups of the polysiloxane. The following are examples of this:

1,12-Dodecanediol dimethacrylate (DDDMA)

Tetramethylene glycol dimethacrylate (TGMDMA)

Triethylene glycol dimethacrylate (TEGDMA)

Ethyl methacrylate (EMA)

Tridecyl methacrylate (C13MA)

Variations of polyethylene glycol methyl ether-methacrylate (MPEG500MA)

Bisphenol-A-ethoxy diacrylate (BED)

Polyethylene glycol-dimethacrylate (PEG400DMA)

Triethylene glycol triacrylate

Trimethylolpropane triacrylate (TMPTA)

These monomers are selected in consideration of the fact that they have different polarities in a molecule, a different number of polymerizable groups, particularly methacryl or acryl groups, and, in the case of more than one polymerizable group, different chain lengths between two polymerizable groups. If monomers having more than one polymerizable group are selected, more dense organically-linked cross-links develop. Mechanical properties, such as elasticity or modulus of elasticity and the like, can be set with the chain length.

The volume of monomeric, organically polymerizable compounds is not critical; in a preferred manner, it is in the range of up to 0.5 mol, more preferably in the range of 0.1 to 0.3 mol per mol of silane used for the siloxane of the formula (I).

The organically-modified material contain polysiloxanes still contains a photoinitiator, at least if polymerization does not occur exclusively via a thiol-ene addition. This can be, for example, an initiator from the Irgacure product line, such as Irgacure 369, Oxe01 or Oxe02, or another initiator, such as Lucirin TPO and TPO-L. In particular, reference should be made to the initiators developed especially for two-photon and multi-photon polymerization, which act through hydrogen abstraction, e.g. Irgacure 369, DPD or N-DPD (1,5-Diphenyl-penta-1,4-diyn-3-on or the ortho-dimethylamino derivative thereof), see e.g. R. Liska et al. in Applied Surface Science 254, 836-840 (2007) and B. Seidl et al. in Macromol. Chem. Phys. 208, 44-54 (2007). Cationic initiators can also be used if the material containing polysiloxanes additionally contains, for example, epoxide groups. Thus, this results in more precise control of the polymerization.

The photoinitiator is preferably added after the inorganic cross-linking of the material has already occurred through hydrolytic condensation of the silane(s) used. For this purpose, it is weighed in and introduced into the material formulation while stirring in yellow light (clean room conditions, yellow light laboratory). Subsequently, the material is ready for use, although it may not yet be filtered, if desired.

The quantity of photoinitiator to be added is not critical—it may be, e.g. in the range of between 0.1 and 5% by weight. 2% by weight is frequently favorable. If the system has double bonds, which cannot be activated, for example, in the form of norbornenyl groups, the quantity of initiator may however be selected significantly less. The photoinitiator may even potentially be left out, namely if thiol-ene links are to be formed, e.g. when reacting a polysiloxane containing norbornenes with a monomeric thiol.

To produce the functionality of three-dimensional molded articles with areas of a different cross-link structure, the material must be exposed. For this purpose, it is introduced onto a substrate or into a mold, wherein it can form a bath in the mold. This can occur through any method known in the state of the art, for example, applying a liquid or pasty material through spin-coating, with a squeegee, through dispensing, compression, submersion or spraying, but also through applying or potentially fastening a previously solidified material on or to a substrate or into or in the mold, wherein all conventional substrate and mold materials can be used, such as glass, silicon or metals, and the layer thickness can be selected fully variably, for example, between 100 nm and several mm. The substrate can be planar, but it can also have an uneven form; molded articles of any (even larger) dimension, particularly a relatively high dimension, can be produced, e.g. in the range of 1-10 mm.

The molded article is subsequently produced through a process comprising two steps. In one, the liquid or pasty or even solid material is selectively solidified on the desired, previously calculated areas, on which the structural change in the finished product is desired, e.g. on those locations that should have a higher refractive index in the finished product, with the help of a laser, preferably an ultra-short pulse laser. For this purpose, a laser beam is directed toward each volume element to be solidified. Radiation with femtosecond laser pulses is particularly suited for this. In principle, solid-state lasers, diode-pumped solid-state lasers, semi-conductor lasers, fiber laser, etc. of any wavelength can be used as a beam source. An Ytterbium laser system is used with particular benefit in one embodiment of the invention. Upon doubling the frequency, its wavelength is in the range of green light. The benefit of Ytterbium lasers compared to titanium-sapphire laser systems, which have a wavelength of approx. 800 nm (wherein, however, the second harmonic can be used at 400 nm), is the wavelength of 1030 nm. Upon doubling the frequency, it is in the green range at 515 nm, which can lead to an improved resolution. Moreover, the materials to be structured can be processed more efficiently than with lasers in wavelength ranges of approx. 800 nm. The process window is significantly larger with respect to material formulations. The benefit of Ytterbium laser systems lies in the fact that these lasers can be pumped with diodes no additional pump laser or various other instruments are necessary. Relatively short pulses constitute the advantage of Ytterbium lasers compared to Nd:YAG lasers. Other short-pulse lasers can also be used in the method pursuant to the invention, particularly fiber lasers. When using larger wavelengths, polymerization can also be initiated by means of n-photon absorption, wherein n is larger than 2. The threshold fluence, at which the polymerization process starts, can be reduced through the selection of suitable components, e.g. co-initiators and/or amine components, with an increased multi-photon absorption cross-section in the resin. Thus, the process window, in which polymerization occurs, becomes enlarged although the material is not yet destroyed. Naturally, the hardened material must be transparent for the laser wavelength used.

The shape and design of the selective range can be freely selected. In some cases, it is beneficial to select a base point on the substrate or on the mold, from which the solidifying structure extends. However, this is not a necessary measure; rather, the structure can be freely written into the material, namely—surprisingly—if it was previously transferred to an already solid state by whichever means. Structures, for example, can be produced that are suited as waveguides.

In a previous or, preferably, subsequent step, the entire material located on the substrate or in the mold is solidified in a preferred, though not the only possible embodiment. This can occur either through irradiation or through heating. If irradiation is used in this step, it preferably occurs with UV light, e.g. in the range of between 200 and 500 nm, very particularly preferably at approx. 365 nm (so-called I line), thus with a roughly doubled energy of the occurring photons, compared with exposure during two-photon polymerization. Thermal solidification occurs preferably at temperatures in the range between 80 and 170° C., wherein the period can be appropriately selected by a specialist depending on the size of the mold and is, e.g. a few seconds to several hours. In one special embodiment, both measures can be combined, wherein the irradiation with UV light is followed by thermal post-hardening. This pre and follow-up treatment assists with the complete hardening so as to ensure that the resulting product also remains stable for long periods of time with respect to optical and mechanical properties. The refractive index difference An will in return become smaller in this process, surprisingly however, it remains in a sufficient amount and is not eliminated, although due to the saturation curves of the TPA reaction, we must assume that all organically polymerizable groups—insofar as not sterically hindered in the process—should be fully reacted in both areas.

In all aforementioned embodiments, it is possible that a cross-linking step precedes the selective solidification step. This is beneficial as the selective exposure for producing the areas with, e.g. a higher refractive index, leads to potentially more precise structures due to the fact that diffusion processes and movement processes in the material are attenuated or prevented, which are caused by the selective energy input and/or, if the sample is moved and not only the laser, the motion of the laser during the exposure process. Surprisingly, the inventors were able to determine that this kind of hardening does not prevent or worsen the following selective production of the desired structure. In the process, it is preferred that the cross-link is caused through irradiation in a photochemical manner. The irradiation may occur with the same wavelengths as previously described; the duration lies at less than one second to approx. 60 minutes, wherein particularly a duration of 1 to 360 seconds, here in turn particularly 5 to 60 seconds, is favorable. This fact that is step does not negatively influence the subsequent selective cross-linking of areas treated with 2PP is a complete surprise if we consider that the materials are already fully cross-linked after 1 to 30 seconds (i.e. until “saturation”), as inventors have known for years from their spectroscopic tests.

Specifically, in particular the five defined processes can be described with the aforementioned measures as follows:

In general, the following applies—if the starting material sued is liquid or pasty, it is introduced onto a substrate or into a mold or a bath. In alternative embodiments, the starting material is already solid (some polysiloxanes, e.g. containing styryl groups, are already solid or semi-solid after the complete hydrolytic condensation). In the first case, the application or introduction may occur through any method known in the state of the art, for example, applying a liquid or pasty material through spin-coating, with a squeegee, through dispensing, compression, submersion or spraying, but also through applying or potentially fastening a previously solidified material on or to a substrate or into or in the mold, wherein all conventional substrate and mold materials can be used, such as glass, silicon or metals, and the layer thickness can be selected fully variably, for example, between 100 nm and several mm. The substrate can be planar, but it can also have an uneven form; molded articles of any (even larger) dimension, particularly a relatively high dimension, can be produced, e.g. in the range of 1-10 mm.

Method 1

In the first step, an ultra-short pulsed laser light focus in produced in the material on the substrate/in the mold by means of a suitable lens. Two-photon polymerization of the starting material located there is achieved in the laser focus. The focus is moved through the material such that the desired volume elements therein are optically polymerized as a result of two-photon or multi-photon polymerization, while the surrounding/adjacent bath material remains unchanged (“laser writing”). After completion of the desired area with TPA or MPA cross-linking, the entire bath will be exposed with UV light in a second step, preferably with a wavelength of 200-500 nm and particularly preferably of 365 nm (I line).

Method 2

This method comprises both steps of method 1. A third step follows, in which the entire bath material is subjected to thermal energy, for example, in an oven or by placing the bath-filled mold onto a hot plate. The duration of this measure is selected according to need, it will be for a few (e.g. 5) minutes up to several (e.g. 8) hours. In the process, the material can be heated at temperatures of particularly between 80 and 170° C. However, higher temperatures cannot be precluded.

Method 3

The starting material used is irradiated with light in a first step, preferably with UV light of a wavelength of 200-500 nm, very particularly preferably of 365 nm (I line). The duration of irradiation is surprisingly not critical; it can be, e.g. between 1 and 3600 seconds, i.e. up to beyond the saturation of the TPA reaction. Even longer exposure times cannot be precluded. The second and third steps correspond with the first and second process step of method 1.

Method 4

The first process step corresponds with the first process step of method 3. The second and third steps correspond with the second (2PP/MPP), and the third process step (thermal hardening) of method 2.

Method 5

According to this method, the starting material used is completely irradiated with light in a first step—as described for method 3. This is followed by the step involving “laser writing” —as described for method 1. Method 5 differentiates from method 3 by the fact that a subsequent solidification is waived.

In all aforementioned variations, additional mechanical pressure may be applied, which is selected depending on the purpose of the application. For this, for example, a planar substrate can be applied from above onto the surface of the layer subject to the method or of the molded article and the resulting “sandwich” is placed in a press.

Organopolysiloxanes organically cross-linked through two-photon or multi-photon polymerization (2PP, MPP), the organically cross-linked groups of which are components of radicals bonded to silicon via carbon, are preferably duroplastic materials, which are distinguished by a high temperature resistance as well as an excellent temperature-dimensional stability compared to most purely organic polymers. Moreover, thiol-ene-cross-linked organopolysiloxanes normally have an adjustable, frequently high-level of flexibility, as can be demonstrated in the 3-point bending and tension test, as well as a broad spectrum of tensile and stretching strengths. Thus, the tensile modulus of elasticity can be set in the range of approx. 1-550 MPa and/or the bending modulus of elasticity can be set in the range of approx. 6-2100 MPa, and depending on the need, an elastic elongation of up to 130% can be achieved until failure in the tension test, wherein values of over 8% are very frequently achievable.

In a second variation not mentioned above as preferred, the (only) step is or all steps of solidification of the entire material are omitted. Thus, first a solidified structure is obtained through “laser writing”, the outer edges of which are surrounded at least partially by a liquid or pasty starting material. Due to the lacking cross-link, said starting material is dissoluble in many solvents, which specialists are aware of, for example, in alcohols, aqueous alcoholic solutions, ketones or mixtures thereof, and can therefore be washed away in a simple manner. A structured molded article or a structured surface remains. This type of method is particularly suitable for the production of molded articles or surfaces having a sophisticated geometry, which can only be produced with the help of forming methods or with exposure with masks. Examples of these types of molded articles are porous molded articles, particularly with pores in the μm or nm range, which can potentially have a non-straight lined geometry. These molded articles are needed, for example, as scaffolds (to allow living cells to grow).

A variety of inorganically cross-linkable organopolysiloxanes (organo-silicic acid polycondensates) usable pursuant to the invention have a low absorption in the range of wavelengths of interest for data and telecommunications (810 to 1550 nm). These polymers can be obtained, for example, if the condensate only has insignificant shares of SiOH groups or is nearly or completely void thereof. A low absorption can be obtained as well, for example, through the use of starting materials, the carbon-containing groups of which are completely or partially fluorinated. Furthermore, it is, e.g. beneficial for this purpose to maintain the share of SiO groups in the resin, i.e. the “inorganic” share, relatively high. This can be done, for example, by adding silanes to the mixture to be hydrolyzed, which contain no organic groups, but rather can be hydrolyzed on all four radicals, e.g. tetra alkoxysilanes, such as tetraethoxysilane. The materials minimally absorbing light in the respective frequency bands in the range of 810 to 1550 nm enable passive and active optical elements to be inexpensively produced with the help of the method pursuant to the invention, the internal optical surfaces of which are very smooth or refined and precisely structured, such as waveguides, prisms, and micro-lenses or even grates.

As mentioned, resins are materials based on organopolysiloxanes, which can be selected in a vast number and variety with respect to various physical, chemical, and biological properties as they can carry a number of different functional groups, which influence the physical and chemical properties of the resin (e.g. cross-link formations, cross-link converters). Thus, these resins are of particular benefit for application in the designated areas. This applies primarily for the use of femtosecond laser irradiation of silane resins preferred pursuant to the invention.

On one hand, the flexibility of the method and the organopolysiloxanes use therefore and their non-toxicity on the other likewise allow for an application in the area of producing any sophisticated, three-dimensional structures from a virtual model on the computer.

The invention is explained in more detail below based on design examples. It has already been made clear that a number of polysiloxanes are suitable for the invention; as their formulation may in turn vary due to the addition of a number of monomers, the following examples are only limited to a few selected starting materials; specialists should be aware that they can instead use any of the materials, the manufacturing of which is described, e.g. in the aforementioned printed publications, and this may analogously vary as well.

### MATERIAL EXAMPLES

General Rule for the Measurement of Mechanical Data

The respective resin is added to a rod mold (2×2×25 mm³) with Lucirin TPO. After the rod hardens under the respective cross-linking conditions, the bending modulus of elasticity and the deflection of the resulting rod (until failure) are determined by means of the 3-point bending test. The tension modulus of elasticity and the maximum elongation of the resulting tensile samples (on a bone-shaped rod; measurement length without bone sections: 21 mm) is determined by means of a tension test.

### Example 1

Synthesis of Base Resin I (Resin with Identical C-Si-Bonded Radicals with One Methacrylate and One Hydroxy Group—see DE 4416857)

For receiving 125.0 g (0.503 mol) of 3-Glycidyloxypropyltrimethoxysilan, 1.31 g (0.005 mol) of triphenylphosphine as a cat., 0.2% by weight of BHT as stabilizer, and subsequently 47.35 g (0.550 mol) of methacrylic acid will added drop-wise in a dry atmosphere and stirred at 80° C. (approx. 24 hours). The reaction can be tracked by inspecting the carboxylic acid concentration by means of acid titration as well as the epoxide volume by means of Raman spectroscopy/epoxide titration. After adding acetic ester (1000 ml/mol of silane) and H₂O to the hydrolysis with HCl as a cat., stir at 30° C. The course of hydrolysis is tracked through water titration. Reconditioning occurs after approx. several days of stirring through multiple solvent extractions with an aqueous NaOH and with water and filtration through a hydrophobized filter. It is first rotated away and then extracted with an oil pump vacuum. The result is a liquid resin without the use of reactive thinners (monomers) with a very low viscosity of approx. 3-6 Pa·s at 25° C. (heavily dependent on the precise hydrolysis and reconditioning conditions) and 0.00 mmol of CO₂H/g (no free carboxyl groups).

The resin is displaced with 1% Lucirin TPO and added to a rod mold (2×2×25 mm³). The (meth)acrylate groups are reacted within the scope of a photo-induced radical polymerization, wherein the resin hardens. The modulus of elasticity of the resulting rod is determined by means of the 3-point bending test after 1.5 days of storage at 40° C. (hardening variation A). The result is presented in Table 1.

### Example 2

Synthesis of a Base Resin System, Based on Base Resin I (see DE 10201105440 A1, Reaction with an Amount of Cyclopentadiene (CP), which is Sufficient for the Complete Reaction of the Double Bonds)

1^{st} attempt: For receiving 132.2 g (0.50 mol) of base resin I, approx. 72.1 g (1.1 mol) of cyclopentadiene (CP) is distilled (by splitting dicyclopentadiene freshly produced, which is also the case in the following examples) while stirring at approx. 90° C. and then continuously stirred for approx. an additional 1-2 hours at 90° C. The reaction can be tracked by means of NMR as well as inspecting the v(C═C, methacryl) bands (1639 cm⁻¹) as well as the formation and increase of v(C═C, norbornenyl bands (1574 cm⁻¹) by means of Raman spectroscopy. The volatile components, such as non-reacted cyclopentadiene, are removed in an oil pump vacuum at temperatures of up to 90° C. The result is a liquid resin with a viscosity of approx. 74-86 Pa·s at 25° C. Additional reconditioning is normally not necessary.

2^{nd} attempt: For receiving 80.0 g (0.30 mol) of base resin I, approx. 45.5 g (0.69 mol) of cyclopentadiene (CP) is distilled under the same conditions as in the 1^{st} attempt and then continuously stirred for approx. 1-2 hours at 90° C. As mentioned above, the reaction can be tracked spectroscopically. The volatile components, such as non-reacted cyclopentadiene, are removed in an oil pump vacuum at temperatures of up to 90° C. The result is a liquid resin with a viscosity of approx. 53-110 Pa·s at 25° C. (heavily dependent on the precise synthesis and reconditioning conditions of the preliminary steps as well). Additional reconditioning is normally not necessary.

The resin from the 2^{nd} attempt is allowed to harden after adding the trithiol TMPMP (trimethylolpropane-(3-mercaptopropionate) (molar ratio SH:C═C=1:1) and 0.5% of Lucirin TPO (light hardening+1.5 days 40° C.=hardening A or light hardening+1.5 days 80° C.=hardening B) or with 1.5 mmol DBPO/100 g of resin and 2.4 mmol of N,N-Bis-2-hydroxyethyl-p-toluidine/100 g of resin (2-comp. hardening at 40° C.=hardening C or 80° C.=hardening D respectively until consistency of the mechanical data) in rod molds (2×2×25 mm³ or in a bone-shaped rod mold with a measurement length section of 21 mm without the bone-shaped ends). In the process, the C═C double bonds of the norbornene groups is reacted within the scope of a photo or redox-induced radical thiol-ene polyaddition.

The modulus of elasticity of the resulting rod is determined by means of the 3-point bending test, wherein the test objects will not break due to the high elasticity—even with a modulus of elasticity. The tension modulus of elasticity and the maximum elongation of the resulting tensile samples (measurement length 21 mm) are determined by means of a tension test. The results are presented in Table 1.

### Example 3

(Reaction of Base Resin I with an Amount of CP, which is Insufficient for the Complete Reaction of the Double Bonds; Production of a Norbornene-Methacrylic Mixing System)

For receiving 26.6 g (0.10 mol) of base resin I, 9.94 g (0.15 mol) of cyclopentadiene (CP) is distilled and then continuously stirred for approx. 1.25 hours at 90° C. The volatile components, such as non-reacted cyclopentadiene, are removed in an oil pump vacuum at temperatures of up to 90° C. The result is a liquid resin (approx. 33 mol % of unreacted methacrylate groups) with a viscosity of approx. 29 Pa·s at 25° C. (heavily dependent on the precise synthesis and reconditioning conditions of the preliminary steps as well). Additional reconditioning is normally not necessary.

After adding the trithiol TMPMP (molar ratio SH:C═C=1:1) and 0.5% of Lucirin TPO (light hardening+1.5 days 40° C.=hardening A) into rod molds, as specified for example 2 the resin is allowed to harden. In the process, the C═C double bonds of the norbornene groups, potentially the methacryl groups as well, is reacted within the scope of a photo-induced radical polyaddition/polymerization.

Modulus of elasticity, tension modulus of elasticity, and maximum elongation is determined as specified for example 2. The results are presented in Table 1.

### Examples 4a-4c

(Synthesis of Base Resin II Using a Respectively Different Shortage of Acrylic Acid Chloride; see DE 10 2011 054 440 A1)

### Example 4a

### Base Resin IIa—Molar Share of Acrylic Acid Chloride=62%, with Respect to the Molar Share of the Hydroxy Groups

For receiving 120.1 g (0.45 mol) of base resin I and 35.1 g of triethylamine (0.347 mol) in 450 ml of THF as a solvent, 28.51 g (0.315 mol) of acrylic acid chloride is added drop-wise in a dry atmosphere and while cooling by means of an ice bath while stirring and then continuously stirred at room temperature. The reaction can be tracked by means of NMR as well as inspecting the acid chloride bands by means of IR spectrum. Following usual reconditioning for separating the amine hydrochloride that developed during the addition and acidic byproducts and extraction of the volatile components with an oil pump vacuum, a liquid resin emerges with a viscosity of approx. 1.5 Pa·s at 25° C. (heavily dependent on the precise synthesis and reconditioning conditions, particularly of the preliminary steps as well).

The resin is displaced with 1% of Lucirin TPO and added to rod molds as specified for example 1. The (meth)acrylate groups are reacted within the scope of a photo-induced, radical polymerization, wherein the resin hardens. The modulus of elasticity of the resulting rod is determined by means of the 3-point bending test after 1.5 days of storage at 40° C. (hardening variation A). The result is presented in Table 2.

### Example 4b

### Base Resin IIb—Molar Share of Acrylic Acid Chloride=74%, with Respect to the Molar Share of the Hydroxy Groups

Example 4a was repeated with a respectively higher amount of acrylic acid chloride.

### Example 4c

### Base Resin IIc—Molar Share of Acrylic Acid Chloride=96%, with Respect to the Molar Share of the Hydroxy Groups

Example 4a was repeated with a respectively higher amount of acrylic acid chloride.

### Example 5

(Reaction of Base Resin IIa According to Example 4 with Cyclopentadiene, wherein a Siloxane Emerges with Radicals Bonded to Silicon Via Carbon, Part of which have One and Part of which have Two Norbornenyl Groups)

For receiving 99.8 g (0.33 mol) of base resin IIa according to example 4, approx. 20.3 g (0.31 mol) of cyclopentadiene (CP) is added drop-wise at approx. 50° C. After heating the reaction mixture to approx. 90° C., 43.0 g (0.65 mol) of CP is distilled and then continuously stirred for approx. 1.5 hours at 90° C. The reaction can be tracked as described above. The volatile components are removed in an oil pump vacuum at temperatures of up to 90° C. The result is a liquid resin with a viscosity of approx. 185 Pa·s at 25° C. Additional reconditioning is normally not necessary.

Hardening (I)

The resin is allowed to harden after adding the trithiol TMPMP (molar ratio SH:C═C=1:1) and 0.5% of Lucirin TPO (light hardening+1.5 days 40° C.=hardening A or light hardening+1.5 days 80° C.=hardening B) or with 1.5 mmol DBPO/100 g of resin and 2.4 mmol of N,N-Bis-2-hydroxyethyl-p-toluidine/100 g of resin (2-comp. hardening at 80° C.=hardening C respectively until consistency of the mechanical data) in rod molds (2×2×25 mm³ or in a bone-shaped rod mold with a measurement length section of 21 mm without the bone-shaped ends). In the process, the C═C double bonds of the norbornene groups are reacted within the scope of a photo or redox-induced, radical polyaddition.

Modulus of elasticity, tension modulus of elasticity, and maximum elongation is determined as specified for example 2. The results are presented in Table 2.

Hardening (II)

The hardening pursuant to (I) is repeated with the modification that the molar ratio is adjusted from SH:C═C to 0.9:1. E Modulus of elasticity, tension modulus of elasticity, and maximum elongation is determined as specified for example 2. The results are presented in Table 2.

### Example 6

Example 5 is repeated with the modification that for receiving 92.4 g (0.03 mol) of base resin Ilb, approx. 22.0 g (0.33 mol) of CP is added drop-wise while stirring at approx. 50° C. After heating the reaction mixture to approx. 90° C., 39.2 g (0.59 mol) of CP is distilled while stirring and then continuously stirred for approx. an additional 1.5 hours at 90° C. The volatile components, such as non-reacted cyclopentadiene, are removed in an oil pump vacuum at temperatures of up to 90° C.

The result is a liquid resin with a viscosity of approx. 380 Pa·s at 25° C. Additional reconditioning is normally not necessary.

The resin is allowed to harden after adding the trithiol TMPMP (molar ratio SH:C═C=1:1) and 0.5% of Lucirin TPO (light hardening+1.5 days 40° C.=hardening A in rod molds as described for example 3. In the process, the C═C double bonds of the norbornene groups are reacted within the scope of a photo-induced, radical polyaddition.

Modulus of elasticity, tension modulus of elasticity, and maximum elongation is determined as specified for example 2. The results are presented in Table 2.

### Example 7

Example 5 is repeated with the modification that for receiving 111.5 g (0.35 mol) of base resin IIc, approx. 33.3 g (0.50 mol) of CP is added drop-wise while stirring at approx. 50° C. After heating the reaction mixture to approx. 90° C., 50.5 g (0.77 mol) of CP is distilled and then continuously stirred for approx. 1 additional hour at 90° C. The volatile components are removed in an oil pump vacuum at temperatures of up to 90° C. The result is a liquid resin with a viscosity of approx. 1030 Pa·s at 25° C. Additional reconditioning is normally not necessary.

The resin is allowed to harden after adding the trithiol TMPMP (molar ratio SH:C═C=1:1) and 0.5% of Lucirin TPO (light hardening+1.5 days 40° C.=hardening A) to rod molds as described for example 3. In the process, the C═C double bonds of the norbornene groups are reacted within the scope of a photo-induced, radical polyaddition.

Modulus of elasticity, tension modulus of elasticity, and maximum elongation is determined as specified for example 2. The results are presented in Table 2.

TABLE 1

| | | | Bending | Tension | |
|---|---|---|---|---|---|
| Resin | | | modulus of | modulus of | |
| system | | Hardening | elasticity | elasticity | Tension-elongation |
| (example) | SH:C═C | variation | [MPa] | [MPa] | [%] |
| 1 | — | A | 1.50 GPa; the samples break during the bending test | | |
| | | | at a deflection of 2.9 mm, i.e. they demonstrate typical | | |
| | | | brittle fracture behavior | | |
| 2 | 1:1 | A | 9.2-9.4 | 3.8-3.9 | 68-81 |
| | | | (no fracture) | | |
| 2 | 1:1 | C | 5.3 | 1.9 | 46 |
| | | | (no fracture) | | |
| 2 | 1:1 | D | 10.3 | 2.9 | 111 |
| | | | (no fracture) | | |
| 3 | 1:1 | A | 14.4 | not ready | not ready |
| | | | (no fracture) | | |

TABLE 2

| | | | | Bending | Tension | |
|---|---|---|---|---|---|---|
| Resin | | | Temp. | modulus of | modulus of | Tension- |
| system | | Hardening | polymerization | elasticity | elasticity | elongation |
| (example) | SH:C═C | variation | [° C.] | [MPa] | [MPa] | [%] |
| 4a | — | A | not ready | 1.74 GPa; the samples break during the | | |
| | | | | bending test at a deflection of 2.9 mm, | | |
| | | | | i.e. they demonstrate typical brittle | | |
| | | | | fracture behavior | | |
| 5 (I) | 1:1 | A | | 1.32 GPa | 390 | 28 |
| | | | | (no fracture) | | |
| 5 (I) | 1:1 | B | | 1.57 GPa | 480 | 27 |
| | | | | (no fracture) | | |
| 5 (I) | 1:1 | C | | 1.44 GPa | 380 | 10 |
| | | | | (no fracture) | | |
| 5 (II) | 0.9:1 | A | | 1.65 GPa | 460 | 19 |
| | | | | (no fracture) | | |
| 5 (II) | 0.9:1 | B | | 1.75 GPa | 520 | 30 |
| | | | | (no fracture) | | |
| 5 (II) | 0.9:1 | C | | 1.37 GPa | 250 | 21 |
| | | | | (no fracture) | | |
| 6 | 1:1 | A | | 1.76 GPa | 520 | 18 |
| | | | | (no fracture) | | |
| 7 | 1:1 | A | | 1.93 GPa | 510 | 19 |
| | | | | (no fracture) | | |
| 7 | 1:1 | B | | 2.10 GPa | 550 | 17 |
| | | | | (no fracture) | | |

### EXAMPLES FOR EXPLAINING THE INVENTION

### Example 8

Reacting the Resin System Pursuant to Example 2 with Trimethylolpropane Tris(3-Mercaptopropionate) (TMPMP) and “Laser Writing” in the Resulting Resin

Variation 1 (with Photoinitiator)

After adding the trithiol TMPMP (molar ratio SH:C═C=1:1), the norbornenyl-functionalized base resin system is displaced with dissolved Lucirin TPO (0.5% by weight) and then applied to any substrate (in this case: a glass substrate) for further processing by means of two-photon or multi-photon absorption. Organic cross-linking is triggered by the femtosecond laser, which initiates a two-photon or multi-photon polymerization process. In the example, a two-photon polymerization process of the resin was triggered by laser light of a wavelength of 515 nm at a repetition rate of 10 MHz However, other wavelengths for exposure and other repetition rates are also possible in any combination. Structures were able to be produced through the laser process in the volume or on the surface of the resin. The structuring was varied with different average laser outputs starting at approx. 4 mW and descended in 0.25 mW increments to an average laser output of 0.25 mW. 17 structures of a size of respectively 25 μm (edge length) with 20 layers, which is equivalent to the selected slice distances of a structure height of approx. 10 μm, were written through a two-photon process. The writing speed was 100 μm/s.

The structuring occurred in a sandwich structure (cover glass above and below, separated by a spacer and a drop of resin formulated with the initiator in between) by means of TPA (2PP) with an immersion objective of a numerical aperture of N.A.=1.4.

After laser structuring, the structures were developed for approx. 3 minutes in a developing bath comprised of a mixture of isopropanol and methyl isobutyl ketone in a mixture ratio of 1:1 and then air-dried and stored. Diagram 1 shows the scanning electron microscopic images of the resulting structures. This examples demonstrates that the material pursuant to the invention can be polymerized under the conditions of TPA, wherein solidified structures with potentially extremely minimal dimensions can be achieved in two of the three spatial directions, which can be used, for example, as photonic structure or as a supporting structure (scaffold) as well with a producible porosity.

Variation 1a (with Photoinitiator)

Like variation 1. The structures are written with TPA in liquid resin, however, only 0.3% by weight of Lucirin is added. In the process, the laser light (wavelength 515 nm) induces a two-photon polymerization (2PP). Through two-photon or multi-photon absorption (TPA/MPA), induced cross-linking processes (in the case of other wavelengths, i.e. processes of a higher order) can likewise be conducted. The structuring occurred in a sandwich structure (cover glass above and below, separated by a spacer and a drop of resin formulated with the initiator in between) by means of TPA (2PP) with an immersion objective of a numerical aperture of N.A.=1.4. The writing speed was 100 μm/s; the energy of the laser was in part 2.0 mW and was reduced for each structure in 0.25 mW increments to 1 mW. The size of a structure recorded in Diagram 2 by means of optical microscopy is 10 μm×10 μm×7.5 μm.

Variation 2 (without Photoinitiator)

After adding the trithiol TMPMP (molar ratio SH:C═C=0.9:1), the norbornenyl-functionalized base resin system is applied to any substrate (in this case: a glass substrate) for further processing by means of multi-photon absorption without adding an initiator. Organic cross-linking is triggered by the femtosecond laser, which initiates a multi-photon polymerization process. In the example, a two-photon polymerization process of the resin was triggered by laser light of a wavelength of 515 nm at a repetition rate of 10 MHz However, other wavelengths for exposure and other repetition rates are also possible in any combination. Structures were able to be produced through the laser process in the volume or on the surface of the resin. The structuring was varied with different average laser outputs starting at approx. 4 mW and descended in 0.25 mW increments to an average laser output of 0.25 mW. 17 structures of a size of respectively 25 μm (edge length) with 20 layers, which is equivalent to the selected slice distances of a structure height of approx. 10 pm, were written through a two-photon process. The writing speed was 100 μm/s s. After laser structuring, the structures were developed for approx. 3 minutes in a developing bath comprised of a mixture of isopropanol and methyl isobutyl ketone in a mixture ratio of 1:1 and then air-dried and stored. Diagram 3 shows the scanning electron microscopic images of the resulting structures, which can be used, for example, as a supporting structure (scaffold) with a producible porosity.

### Example 9

### With Photoinitiator, Pre-Solidified Material

After adding the trithiol TMPMP (molar ratio SH:C═C=0.5:1), the norbornenyl-functionalized base resin system is applied to any substrate (in this case: a glass substrate) pursuant to example 2 (variation 1) with 0.3% by weight of Lucirin. The resin is pre-exposed prior to TPA or MPA by means of light of a wavelength of 200 to 500 nm, wherein this pre-exposure can last between 1 and 3600 seconds. In the selected example, the pre-exposure time was 360 seconds, such that the material was completely solidified. The laser was then focused on the solidified material by means of an objective of a numerical aperture of 1.4 and structures were thus produced in the material by means of TPA when using a wavelength of 515 nm. In the process, the laser light induced an additional cross-linking/compaction of the pre-cross-linked material through two-photon polymerization (2PP). Through multi-photon absorption (TPA/MPA), induced cross-linking processes (in the case of other wavelengths, i.e. processes of a higher order) can likewise be conducted. The structures are present in the molded article or the layer as volume structures and are not developed (solvent-free process).

A refractive index travel time is produced through the structuring. This can be demonstrated indirectly based on images with the incident light microscope, which are attached as Diagram 4 (a) and (b) and the light delivery can be identified within the “written” structures—only if a refractive index difference between the “written” structure and its surroundings is present will total reflection occur on the border of the structure to its surroundings, such that the structure can function as a waveguide.

What is claimed is:

1. A layer or three-dimensional molded article comprised of an organically modified polysiloxane or a derivative thereof, the silicon atoms of which are fully or partially replaced by other metal atoms, wherein the organic share of the polysiloxane or derivative thereof has an organic cross-link with thiol-ene addition products bonded to silicon and/or to other metal atoms via carbon and/or oxygen, which are obtainable via a two-photon or multi-photon polymerization reaction, wherein the article has two areas with differing primary and/or secondary structures, available through the following process:
a) Providing a substrate or a mold,
b) Providing a material selected from sols, gels, and organically modified materials containing polysiloxanes, all of which contain metal and/or metalloid, wherein said material has free SH groups and isolated C═C double bonds,
c) Applying or attaching the provided material on or to the substrate or pouring it into the mold,
d) Selective exposure of a selected area of material located on the substrate or in the mold with the help of two-photon or multi-photon polymerization, and
e) Thermal and/or photochemical treatment of the entire material located on the substrate or in the mold,
with the provision that steps d) and e) can be conducted in any sequence.

2. A layer or three-dimensional molded article according to claim 1, wherein the material provided according to step (b) is selected from the group consisting of:
1. A mixture comprised of (a) a material having organic groups bonded to the metal/metalloid via an oxygen bridge or via a carbon atom, which are substituted with one or more SH groups, and (b) a purely organic compound having two or more isolated C═C bonds,
2. A mixture comprised of (a) a material having organic groups bonded to the metal/metalloid via an oxygen bridge or via a carbon atom, which have two or more isolated C═C bonds and (b) a purely organic compound, which are substituted with one or more SH groups, and
3. A mixture comprised of (a) a material having organic groups bonded to the metal/metalloid via an oxygen bridge or via a carbon atom, which are substituted with one or more SH groups, and (b) having organic groups bonded to the metal/metalloid via an oxygen bridge or via a carbon atom, which have one or more isolated C═C bonds.

3. A layer or three-dimensional molded article according to claim 1, wherein the material provided according to step (b) is an organically modified material containing polysiloxanes.

4. A layer or three-dimensional molded article according to claim 1, wherein the material provided according to step (b) comprises an organically modified material containing polysiloxanes, which is obtainable through hydrolysis and at least partial condensation of a starting material comprising at least one silane of a formula (I),
R¹ₐR²_{b}SiX_{4-a-b} (I)
wherein R¹ is equal or different and represents a radical polymerizable via two-photon or multi-photon polymerization, which carries at least one isolated C═C double bond, R² is equal or different and represents an organic radical that is not polymerizable in this manner, and X is a radical that can be hydrolyzed out of silicon under hydrolysis conditions, the index a represents 1, 2 or 3, the index b represents 1 or 2, and a+b together are 1, 2 or 3, as well as thiosilane or an organic thiol with at least two SH groups.

5. A layer or three-dimensional molded article according to claim 3, wherein the material provided according to step (b) comprises an organically modified material containing polysiloxanes, which is obtainable through hydrolysis and at least partial condensation of a starting material comprising at least one silane of a formula (I′),
R³ₐR²_{b}SiX_{4-a-b} (I′)
wherein R³ is equal or different and represents an organic radical capable of polyaddition via two-photon or multi-photon polymerization, which carries at least one SH group, R² is equal or different and represents an organic radical that is not polymerizable in this manner, and X is a radical that can be hydrolyzed out of silicon under hydrolysis conditions, the index a represents 1, 2 or 3, the index b represents 1 or 2, and a+b together are 1, 2 or 3, as well as a silane of said formula (I) as specified in claim 3, or an organic compound containing at least one isolated C═C double bond.

6. A layer or three-dimensional molded article according to claim 1, wherein the areas with different primary and/or secondary structures have different refractive indices.

7. A layer or three-dimensional molded article according to claim 1, wherein the areas with different primary and/or secondary structures have different cross-linking structures.

8. A method for producing a three-dimensional layer or a three-dimensional molded article having two areas with different primary and/or secondary structures, comprising:
a) Providing a substrate or a mold,
b) Providing a material selected from sols, gels, and organically modified materials containing polysiloxanes, all of which contain metal and/or metalloid, wherein said provided material is selected from sols, gels, and organically modified materials containing polysiloxanes containing metal and/or metalloid and has free SH groups and isolated C=C double bonds,
c) Applying or attaching the provided material on or to the substrate or pouring it into the mold,
d) Selective exposure of a selected area of material located on the substrate or in the mold with the help of two-photon or multi-photon polymerization, and
e) Thermal and/or photochemical treatment of the entire material located on the substrate or in the mold,
with the provision that steps d) and e) can be conducted in any sequence.

9. A method according to claim 8, wherein the material provided according to step (b) is selected from the group consisting of:
1. A mixture comprised of (a) a material having organic groups bonded to the metal/metalloid via an oxygen bridge or via a carbon atom, which are substituted with one or more SH groups, and (b) a purely organic compound, which has two or more isolated C=C bonds,
2. A mixture comprised of (a) a material having organic groups bonded to the metal/metalloid via an oxygen bridge or via a carbon atom, which have one or more isolated C═C double bonds, and (b) a purely organic compound, which is substituted with two or more SH groups, and
3. A mixture comprised of (a) a material having organic groups bonded to the metal/metalloid via an oxygen bridge or via a carbon atom, which are substituted with one or more SH groups, and (b) having organic groups bonded to the metal/metalloid via an oxygen bridge or via a carbon atom, which have one or more isolated C═C bonds.

10. A method according to claim 8, wherein the areas with different primary and/or secondary structures have different refractive indices.

11. A method according to claim 8, wherein the areas with different primary and/or secondary structures have different cross-linking structures.

12. A method according to claim 8, wherein the material provided according to step (b) is an organically modified material containing polysiloxanes.

13. A method according to claim 12, wherein the material provided according to step (b) comprises an organically modified material containing polysiloxanes, which is obtainable through hydrolysis and at least partial condensation of a starting material comprising at least one silane of a formula (I),
R¹ₐR²_{b}SiX_{4-a-b} (I)
wherein R¹ is equal or different and represents a radical polymerizable via two-photon or multi-photon polymerization, which carries at least one isolated C═C double bond, R² is equal or different and represents an organic radical that is not polymerizable in this manner, and X is a radical that can be hydrolyzed out of silicon under hydrolysis conditions, the index a represents 1, 2 or 3, the index b represents 1 or 2, and a+b together are 1, 2 or 3, as well as a thiosilane or an organic thiol with at least two SH groups.

14. A method according to claim 13, wherein R¹ is a radical containing a non-aromatic C═C double bond, preferably a α,β-unsaturated carbonyl compound and/or wherein R² is potentially substituted alkyl, aryl, alkylaryl or arylalkyl, wherein the carbon chain of these radicals can be broken by a coupling group, preferably selected from among O, S, NH, COHN, COO, NHCOO, and/or wherein X is hydrogen, halogen, hydroxy, alkoxy, acyloxy or NR⁵₂ with R⁵ equal to hydrogen or lower alkyl.

15. A method according to claim 13, wherein the material provided according to step (b) comprises an organically modified material containing polysiloxanes, which is obtainable through hydrolysis and at least partial condensation of a starting material comprising at least one silane of a formula (I′),
R³ₐR²_{b}SiX_{4-a-b} (I′)
wherein R³ is equal or different and represents an organic radical capable of polyaddition via two-photon or multi-photon polymerization, which carries at least one SH group, R² is equal or different and represents an organic radical that is not polymerizable in this manner, and X is a radical that can be hydrolyzed out of silicon under hydrolysis conditions, the index a represents 1, 2 or 3, the index b represents 1 or 2, and a+b together are 1, 2 or 3, as well as a silane of said formula (I) as specified in claim 13 or an organic compound containing at least one isolated C═C double bond.

16. A method according to claim 12, wherein the starting material also contains at least one additional silane of a formula (II),
SiX₄ (II)
wherein X is equal or different and has the same meaning as in formula (I).

17. A method according to claim 12, wherein the starting material also contains at least one additional silane of a formula (III),
R⁴ₐSi(OH)₄₋ₐ (III)
wherein R⁴ can be equal or different and has either the meaning of R¹ as defined in formula (I) or of R² as defined in formula (I), and wherein the index a represents 1, 2 or 3.

18. A method for producing a three-dimensional layer or a three-dimensional molded article comprising:
a) Providing a substrate or a mold,
b) Providing a material selected from sols, gels, and organically modified materials containing polysiloxanes, all of which contain metal and/or metalloid, wherein said provided material is selected from sols, gels, and organically modified materials containing polysiloxanes containing metal and/or metalloid and has free SH groups and isolated C═C double bonds,
c) Applying or attaching the provided material on or to the substrate or pouring it into the mold,
d) Selective exposure of a selected area of material located on the substrate or in the mold with the help of two-photon or multi-photon polymerization, and
e) Separating the molded article from non-exposed material by washing the article in a solvent, in which the provided material dissolves pursuant to step (b).

19. A method according to claim 18, wherein the material provided according to step (b) is selected from the group consisting of:
1. A mixture comprised of (a) a material having organic groups bonded to the metal/metalloid via an oxygen bridge or via a carbon atom, which are substituted with one or more SH groups, and (b) a purely organic compound, which has two or more isolated C═C bonds,
2. A mixture comprised of (a) a material having organic groups bonded to the metal/metalloid via an oxygen bridge or via a carbon atom, which have one or more isolated C═C double bonds, and (b) a purely organic compound, which is substituted with two or more SH groups, or
3. A mixture comprised of (a) a material having organic groups bonded to the metal/metalloid via an oxygen bridge or via a carbon atom, which are substituted with one or more SH groups, and (b) having organic groups bonded to the metal/metalloid via an oxygen bridge or via a carbon atom, which have one or more isolated C═C bonds.

20. A method according to claim 18, wherein the material provided according to step (b) is an organically modified material containing polysiloxanes.

21. A method according to claim 20, wherein the material provided according to step (b) comprises an organically modified material containing polysiloxanes, which is obtainable through hydrolysis and at least partial condensation of a starting material comprising at least one silane of a formula (I),
R¹ₐR²_{b}SiX_{4-a-b} (I)
wherein R¹ is equal or different and represents a radical polymerizable via two-photon or multi-photon polymerization, which carries at least one isolated C═C double bond, R² is equal or different and represents an organic radical that is not polymerizable in this manner, and X is a radical that can be hydrolyzed out of silicon under hydrolysis conditions, the index a represents 1, 2 or 3, the index b represents 1 or 2, and a+b together are 1, 2 or 3, as well as a thiosilane or an organic thiol with at least two SH groups.

22. A method according to claim 21, wherein R¹ is a radical containing a non-aromatic C═C double bond, preferably a α,β-unsaturated carbonyl compound and/or wherein R² is potentially substituted alkyl, aryl, alkylaryl or arylalkyl, wherein the carbon chain of these radicals can be broken by a coupling group, preferably selected from among O, S, NH, COHN, COO, NHCOO, and/or wherein X is hydrogen, halogen, hydroxy, alkoxy, acyloxy or NR⁵₂ with R⁵ is equal to hydrogen or lower alkyl.

23. A method according to claim 21, wherein the material provided according to step (b) comprises an organically modified material containing polysiloxanes, which is obtainable through hydrolysis and at least partial condensation of a starting material comprising at least one silane of a formula (I′),
R³ₐR²_{b}SiX_{4-a-b} (I′)
wherein R³ is equal or different and represents a radical polymerizable via two-photon or multi-photon polymerization, which carries at least one SH group, R² is equal or different and represents an organic radical that is not polymerizable in this manner, and X is a radical that can be hydrolyzed out of silicon under hydrolysis conditions, the index a represents 1, 2 or 3, the index b represents 1 or 2, and a+b together are 1, 2 or 3, as well as a silane of said formula (I),
R¹ₐR²_{b}SiX_{4-a-b} (I)
wherein R¹ is equal or different and represents a radical polymerizable via two-photon or multi-photon polymerization, which carries at least one isolated C═C double bond, R² is equal or different and represents an organic radical that is not polymerizable in this manner, and X is a radical that can be hydrolyzed out of silicon under hydrolysis conditions, the index a represents 1, 2 or 3, the index b represents 1 or 2, and a+b together are 1, 2 or 3, as well as a thiosilane or an organic thiol with at least two SH groups,
or an organic compound containing at least one isolated C═C double bond.

24. A method according to claim 20, wherein the starting material also contains at least one additional silane of a formula (II),
SiX₄ (II)
wherein X is equal or different and has the same meaning as in formula (I).

25. A method according to claim 20, wherein the starting material also contains at least one additional silane of a formula (III),
R⁴ₐSi(OH)₄₋ₐ (III)
wherein R⁴ can be equal or different and has either the meaning of R¹ as defined in formula (I) or of R² as defined in formula (I), and wherein the index a represents 1, 2 or 3.

26. A method according to claim 18 for producing a porous molded article, particularly a molded article with pores in the μm or nm range and/or a molded article suitable as a scaffold.

27. Layer or three-dimensional molded article according to claim 1 in the shape of a waveguide.
